(19) United States
(12) Patent Application Publication
(10) Pub. No.: US 2015/0283480 A1
(43) Pub. Date: Oct. 8, 2015

(54) DEBUBBLER APPARATUS

(71) Applicant: TRUSVAL TECHNOLOGY CO., LTD., Miao-Li Hsien (TW)

(72) Inventor: Shih-Pao CHIEN, Miao-Li Hsien (TW)

(73) Assignee: TRUSVAL TECHNOLOGY CO., LTD., Miao-Li Hsien (TW)

(21) Appl. No.: 14/614,437

(22) Filed: Feb. 5, 2015

(30) Foreign Application Priority Data
Apr. 2, 2014 (TW) 103205686

(51) Int. Cl. B01D 19/00

(52) U.S. Cl. CPC B01D 19/0042

(57) ABSTRACT

A debubbler apparatus includes a debubbler tank, and a liquid inlet tube, a liquid outlet tube and a gas venting tube, all connected to the debubbler tank; wherein the debubbler tank including a first tank and a second tank, vertically connected to each other; the second tank starting to shrink in diameter gradually from the top connected to first tank downward; the liquid inlet tube being disposed at the first tank and linked to the inside of the first tank; the liquid outlet tube being disposed at the second tank and connected to the bottom of the second tank; the gas venting tube being disposed at the first tank and connected to a gas chamber inside the first tank. As such, the liquid injected into the tank causes a swirl, resulting in gas concentrated in the gas chamber for venting to accomplish debubbling.

### CROSS-REFERENCE TO RELATED APPLICATION

The present application is based on, and claims priority form, Taiwan Patent Application No. 103205686, filed Apr. 2, 2014, the disclosure of which is hereby incorporated by reference herein in its entirety.

### TECHNICAL FIELD

The technical field generally relates to a debubbler apparatus, and in particular, more related to a technique using fluid to concentrate the gas in a liquid pipe to the central part of the debubbler apparatus and using buoyancy to surface for collection and venting.

### BACKGROUND

In chemical engineering process, the bubbles often exist in pipes to affect the yield rate of the process. The known technique often employs a temporary storage tank to reduce the flow speed so that the bubbles surfacing due to buoyancy are then collected and vented. FIG. 1 shows a schematic view of a known debubbler apparatus using temporary storage tank. As shown in FIG. 1, the debubbler apparatus includes a buffer tank 10, a liquid inlet tube 11 connected to the tank, a liquid outlet tube 12 and a gas venting tube 13. The buffer tank 10 has a cylinder shape. The liquid inlet tube 11 is an L-shaped tube, extending into the tank 10 with the opening facing upwards. The liquid outlet tube 12 is connected to the side wall of the tank 10, and the gas venting tube 13 is connected to the top of the tank 10. When the liquid enters the tank 10 through the liquid inlet tube 11, the flow speed slows down because the cross-section area of the tank 10 is larger than the cross-section area of the liquid inlet tube 11. In addition, because of the upward opening of the tube, the bubbles surface due to the buoyancy effect and concentrate inside the tank 10. After accumulation, the gas from the bubbles is vented out through the gas venting tube 13. The above apparatus shows the following disadvantages:

1. If the flow speed inside the tank 10 is faster than the speed at which the bubbles surface, the bubbles will flow along with the liquid from the liquid outlet tube 12 and the de-bubble effect is failed to achieved.

2. If the bubbles are very small, the surfacing speed is too slow to be effectively surfacing to the top portion inside the tank 10.

3. The flow speed inside the tank 10 must be slow, which may easily cause residual deposited at the bottom of the tank 10.

4. The size of the tank 10 must be larger than the size of the tubes to achieve slow flow speed, which takes up more space.

### SUMMARY

An exemplary embodiment describes a debubbler apparatus to allow a liquid to enter a tank at a specific angle. Combined with the specific shape of the tank, the kinetic of the liquid inside the tank causes a swirl current, resulting in a centrifugal force to make the liquid and the gas to flow at different speeds so that the gas is easily concentrated around the center and surfaces due to the buoyancy. The surfaced gas is collected and vented to accomplish the object of de-bubbling.

To achieve the above object, the present disclosure provides a debubbler apparatus, including a debubbler tank, and a liquid inlet tube, a liquid outlet tube and a gas venting tube, all connected to the debubbler tank; wherein the debubbler tank including a first tank and a second tank, vertically connected to each other; the second tank starting to shrink in diameter gradually from the top connected to the first tank downward; when the liquid entering the debubbler tank, a gas chamber being formed inside the first tank above the liquid level; the liquid inlet tube being disposed at the first tank and linked to the inside of the first tank; the liquid outlet tube being disposed at the second tank and connected to the bottom of the second tank; the gas venting tube being disposed at the first tank and connected to the gas chamber inside the first tank.

With the present apparatus, after the liquid enters the tank, the liquid kinetic causes a swirl. The flow speed inside the pipes of the system will not slow down to cause the residual deposition problem. No additional driving device is necessary to drive the liquid. As such, the size can be kept small.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a known debubbler apparatus using temporary storage tank;

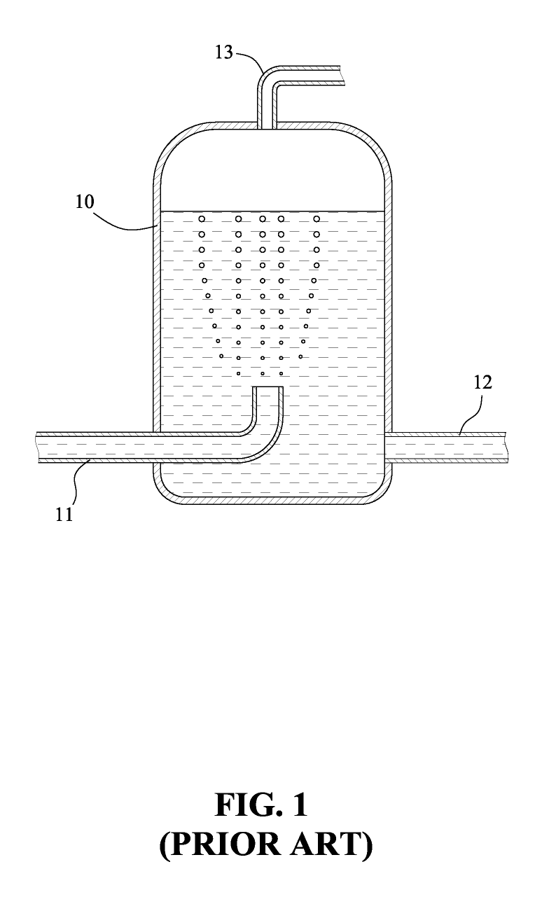

FIG. 2 shows a schematic view of an embodiment of the present disclosure;

FIG. 3 shows a cross-sectional view of FIG. 2 along the AA perspective;

FIG. 4 shows a cross-sectional view of FIG. 2 along the BB perspective;

FIG. 5 shows a schematic view of the actual operation of the present disclosure; and

FIG. 6 shows a schematic view of another embodiment of the present disclosure.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

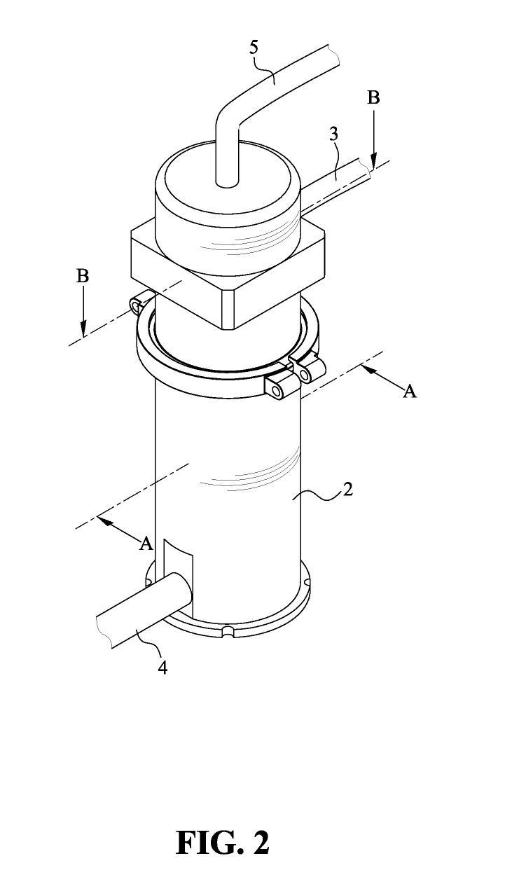

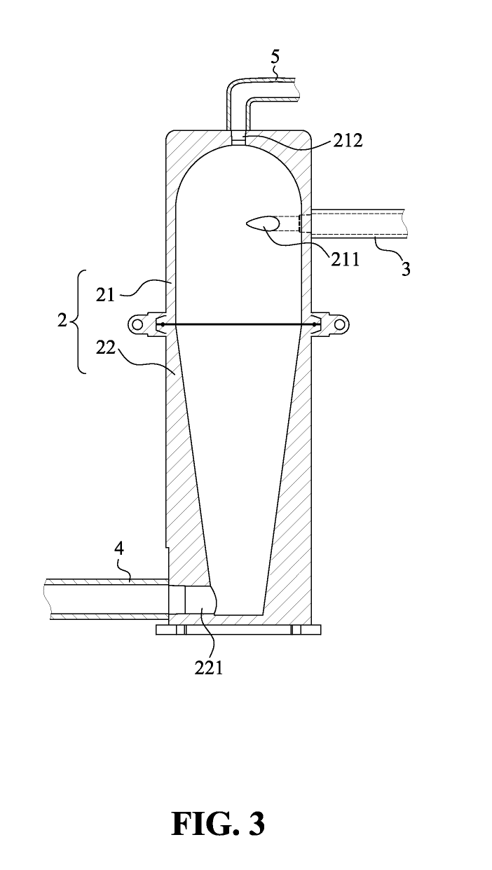

FIG. 2 and FIG. 3 show a schematic view and a cross-sectional view of an embodiment of the present disclosure respectively. A debubbler apparatus of the present disclosure includes a debubbler tank 2, and at least a liquid inlet tube 3, a liquid outlet tube 4 and a gas venting tube 5, all connected to the debubbler tank 2.

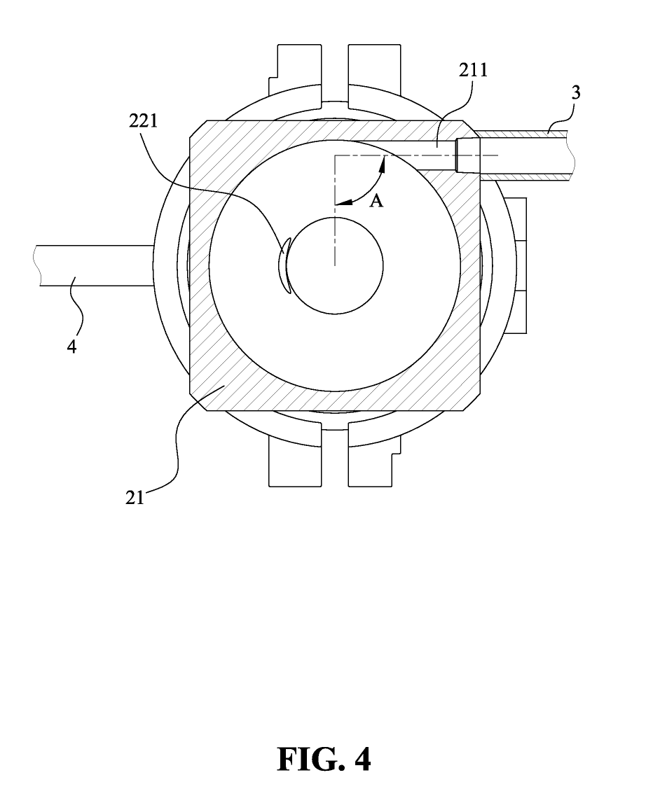

The debubbler tank 2 is a sealed hollow container, including a first tank 21 and a second tank 22, vertically connected to each other. The first tank 21 has a cylinder shape, with the same diameter for most of the part. A liquid inlet hole 211 is disposed on the wall of the first tank 21. The angle at which the liquid enters the first tank 21 has a direct impact on the debubbler effect. As shown in FIG. 4, the liquid inlet hole 211 has a center line forming an angle A with a diameter of the tank. The angle A ranges from 70° to 110°. Preferably, the angle is 90° and located on the tangent direction of the inner wall of the first tank 21. The diameter of top part of the first tank 21 shrinks gradually towards the top of the tank, and a gas venting hole 212 is disposed at the center of the top. The second tank 22 starts to shrink in diameter gradually from the top connected to the first tank 21 downward. If the shrinkage in diameter is linear, the inner wall will have a conic shape, as the shape inside the second tank 22. If the shrinkage in diameter is non-linear, the inner wall has an arc conic shape, as the shape inside the top part of the first tank 21. A liquid outlet hole 221 is disposed near the bottom of the second tank 22. When the liquid is injected into the debubbler tank 2, a gas chamber being formed inside the first tank between the liquid level and the inner wall.

The liquid inlet tube 3 is disposed at the first tank 21 and linked to the liquid inlet hole 211. The liquid outlet tube 4 is disposed at the second tank 22 at the location on a vertical side wall at the bottom of the second tank 22. The liquid outlet tube 4 is connected to the liquid outlet hole 221. To eliminate the bubbles from the pipes in the system, the liquid inlet tube 3 and the liquid outlet tube 4 are disposed in a liquid supply system serially. The gas venting tube 5 is disposed at the first tank 21 and connected to the gas venting hole 212 of the first tank 21.

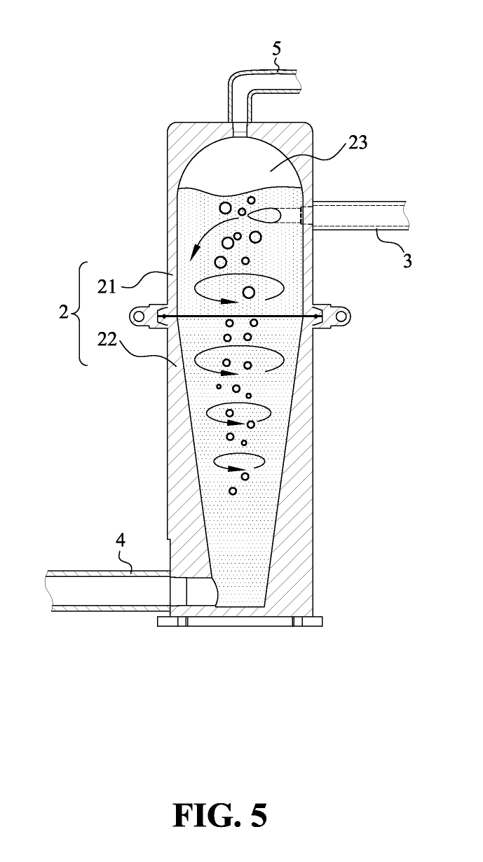

FIG. 5 shows a schematic view of the actual operation of the present disclosure. The present disclosure uses a specific angle of the liquid inlet hole 211 so that when a liquid enters the debubbler tank 2 through the liquid inlet tube 3, the liquid kinetic will cause a swirl inside the tank, resulting in a centrifugal force to make the liquid and the gas to flow at different speeds. The liquid is on the outskirt while the gas is easily concentrated around the center. The smaller bubbles gather to become larger bubbles and surface due to the buoyancy to form a gas chamber 23 above the liquid level inside the first tank 21. Finally, the surfaced gas is vented out through the gas venting hole 212 and gas venting tube 5 to accomplish the object of de-bubbling. The debubbled liquid is outputted through the liquid outlet tube 4.

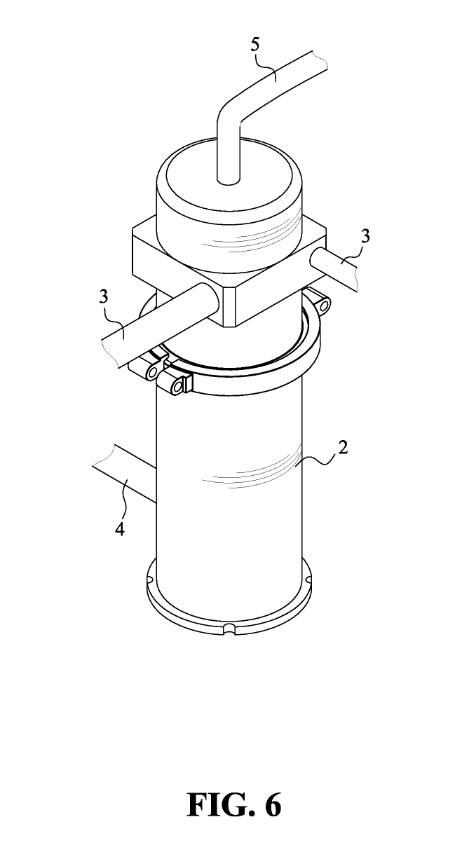

FIG. 6 shows a schematic view of another embodiment of the present disclosure. In the instant embodiment, the debubbler tank 2 is still connected to the liquid inlet tube 3, the liquid outlet tube 4 and the gas venting tube 5. The difference is that there are two liquid inlet tubes 3. The two liquid inlet tubes 3 are connected respectively to two liquid inlet holes 211 to enter the first tank 21. The same liquid or two different liquids can enter the first tank 21 through the two liquid inlet tubes 3. If different liquids are used, the instant embodiment can be used to accomplish mixing as well as debubbling.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A debubbler apparatus, comprising:
a debubbler tank, further comprising: a first tank and a second tank, vertically connected to each other; the second tank starting to shrink in diameter gradually from the top connected to the first tank downward; when a liquid entering the debubbler tank, a gas chamber being formed inside the first tank above the liquid level;
a liquid inlet tube, disposed at the first tank and linked to the inside of the first tank;
a liquid outlet tube, disposed at the second tank and connected to the bottom of the second tank; and
a gas venting tube, disposed at the first tank and connected to the gas chamber inside the first tank.

2. The debubbler apparatus as claimed in claim 1, wherein the diameter of top part of the first tank shrinks gradually towards the top of the first tank, a gas venting hole is disposed at the center of the top, and the gas venting tube is connected to the gas venting hole.

3. The debubbler apparatus as claimed in claim 1, wherein the first tank is disposed with at least a liquid inlet hole on the wall, the liquid inlet hole has a center line forming an angle ranging from 70° to 110° with a diameter of the tank, and the liquid inlet tube is connected to the liquid inlet hole.

4. The debubbler apparatus as claimed in claim 1, wherein the liquid outlet tube is disposed on the outer wall of the second tank at the bottom and is connected to a liquid outlet hole at the bottom of the second tank.
